(19) United States
(12) Patent Application Publication
(10) Pub. No.: US 2020/0394031 A1
(43) Pub. Date: Dec. 17, 2020

(54) METHOD AND SYSTEM FOR SOFTWARE UPDATE OF VEHICLE

(71) Applicants: HYUNDAI MOTOR COMPANY, SEOUL (KR); KIA MOTORS CORPORATION, SEOUL (KR)

(72) Inventors: Yong Hyun Kim, Seoul (KR); Seungwon Park, Seoul (KR); Sunho Choi, Hwaseong-si (KR); Sungtae Kim, Seoul (KR)

(21) Appl. No.: 16/662,787

(22) Filed: Oct. 24, 2019

(30) Foreign Application Priority Data
Jun. 17, 2019 (KR) 10-2019-0071495

(51) Int. Cl. G06F 8/65; B60R 16/033; B60W 50/00; H02J 7/00

(52) U.S. Cl. CPC G06F 8/65; B60R 16/033; B60W 2510/244; H02J 7/0068; B60W 2050/0083; B60W 50/00

(57) ABSTRACT

The method and system for software update of a vehicle according to an aspect of the present disclosure may securely complete the software update of the vehicle by sufficiently securing the battery charge in consideration of the software update of the vehicle. A method for software update of a vehicle according to an aspect of the present disclosure includes: securing a battery charge amount required for a software update of the vehicle by charging the battery while the engine of the vehicle is turned on; and performing the software update of the vehicle using the power of the battery while the engine of the vehicle is turned off.

### CROSS-REFERENCE TO RELATED APPLICATION

This application claims the benefit of Korean Patent Application No. 10-2019-0071495, filed on Jun. 17, 2019 in the Korean Intellectual Property Office, the disclosure of which is incorporated herein by reference.

### BACKGROUND

### 1. Technical Field

The present disclosure relates to a vehicle, and more particularly, to power management of a battery in consideration of a software update of the vehicle.

### 2. Description of the Related Art

As electronic control technology is developed, various electronic control technologies are applied to vehicles. As the electronic control technology is applied to a vehicle, the control for various devices of the vehicle by an electronic control unit (ECU) is performed. In order for the ECU to control various devices in the vehicle, it is necessary to run software (or firmware). Such software may be changed or improved as necessary. This is accomplished by a software update that replaces existing software with new or modified software.

The software update of the vehicle was performed by connecting a storage device storing data for software update to the vehicle by wire. However, due to the development of communication technology, recently, data is wirelessly received (downloaded) through a wireless communication network to perform necessary software update. Such software update using a wireless communication network is referred to as an OTA (Over The Air) type software update.

If the battery is low during such a software update, the software update will be stopped before it is completed. In this case, it is impossible to operate the software stably, which may cause the electronic control of the vehicle by the ECU to be unstable. In addition, a situation in which the engine may not be restarted may occur due to the battery discharge of the vehicle.

### SUMMARY

The method and system for software update of a vehicle according to an aspect of the present disclosure may securely complete the software update of the vehicle by sufficiently securing the battery charge in consideration of the software update of the vehicle.

In accordance with an aspect of the present disclosure, a method for software update of a vehicle includes: securing a battery charge amount required for a software update of the vehicle by charging the battery while the engine of the vehicle is turned on; and performing the software update of the vehicle using the power of the battery while the engine of the vehicle is turned off.

The method further includes: receiving a software update request; and charging the battery and performing the software update in response to the software update request.

The method further includes: receiving a data required for software update of the vehicle in response to receiving the software update request.

The method further includes: receiving the data necessary for software update of the vehicle while the engine of the vehicle is turned on.

The method further includes: estimating a current amount required for software update of the vehicle in response to receiving the software update request; and setting a target current amount of the battery based on the estimated current amount.

The securing the battery charge amount includes: maintaining the state of the battery charge such that the battery charge amount exceeds the current amount required for the software update while the engine of the vehicle is turned on.

The software update of the vehicle includes a software update of the over-the-air (OTA) type software update for receiving the data necessary for the software update of the vehicle through a wireless communication network.

In accordance with another aspect of the present disclosure, a system for software update of vehicle includes: a detector for detecting a battery charge amount; and a controller configured to secure the battery charge amount required for software update of the vehicle by charging the battery while the engine of the vehicle is turned on and perform the software update of the vehicle using the power of the battery while the engine of the vehicle is turned off.

The controller is configured to receive a software update request, charge the battery and perform the software update in response to the software update request.

The controller is configured to receive a data required for software update of the vehicle in response to receiving the software update request.

The controller is configured to receive the data necessary for software update of the vehicle while the engine of the vehicle is turned on.

The controller is configured to estimate a current amount required for software update of the vehicle in response to receiving the software update request and set a target current amount of the battery based on the estimated current amount.

The securing a battery charge amount includes: maintaining the state of the battery charge such that the battery charge amount exceeds the current amount required for the software update while the engine of the vehicle is turned on.

The software update of the vehicle includes a software update of the over-the-air (OTA) type software update for receiving the data necessary for the software update of the vehicle through a wireless communication network.

In accordance with another aspect of the present disclosure, a method for software update of a vehicle includes: receiving an OTA type software update request; securing a battery charge amount required for a software update of the vehicle by charging the battery while the vehicle is driving; receiving a data necessary for software update of the vehicle while the vehicle is driving in response to receiving the software update request; and performing the software update of the vehicle using the power of the battery while the vehicle is parked.

The method further includes: estimating a current amount required for software update of the vehicle in response to receiving the software update request; and setting a target current amount of the battery based on the estimated current amount.

The securing the battery charge amount includes: maintaining the state of the battery charge such that the battery charge amount exceeds the current amount required for the software update while the engine of the vehicle is turned on.

In accordance with another aspect of the present disclosure, a method for software update of a vehicle includes: receiving an OTA type software update request; estimating a current amount required for software update of the vehicle in response to receiving the software update request; setting a target current amount of the battery based on the estimated current amount; control the battery charge amount to be maintained above the target current amount by charging the battery while the vehicle is driving; receiving a data necessary for software update of the vehicle while the vehicle is driving in response to receiving the software update request; and performing the software update of the vehicle using the power of the battery while the vehicle is parked.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating the exterior of a vehicle according to an embodiment of the present disclosure.

FIG. 2 is a block diagram illustrating a configuration of a software update system of a vehicle according to an embodiment of the present disclosure.

FIG. 3 is a diagram illustrating a software update method of a vehicle according to an exemplary embodiment of the present disclosure.

FIG. 4 is a view illustrating a state change of a battery during software update according to an exemplary embodiment of the present disclosure.

### DETAILED DESCRIPTION

In the description of the present disclosure, drawings and embodiments shown in the drawings are preferred examples of the disclosed disclosure, and there can be various modifications that can replace the embodiments and the drawings of the present disclosure at the time of filing of the present disclosure.

In addition, the same reference numerals or the same symbols used in the drawings of the present disclosure indicate elements that perform substantially the same function.

In addition, the terms used in the present disclosure are intended to illustrate the embodiments of the present disclosure and are not intended to limit or limit the present disclosure. The singular forms “a”, “an” and “the” include plural referents unless the context clearly dictates otherwise. In the present disclosure, terms such as “include,” “include,” or “have” are intended to specify that there are features, numbers, steps, acts, components. Also, it does not preclude the presence or addition of one or more other features, numbers, steps, operations, components, components, or combinations thereof.

It is also to be understood that terms including ordinals such as “first”, “second”, etc. used herein may be used to describe various elements, but the elements are not limited to these terms. It is used only for the purpose of distinguishing one component from another. For example, without departing from the scope of the present disclosure, the first component may be referred to as a second component, and similarly, the second component may also be referred to as a first component. The term “and/or” includes any combination of a plurality of related listed items or any of a plurality of related listed items.

Hereinafter, with reference to the accompanying drawings, embodiments of the software update method and system of the vehicle will be described in detail.

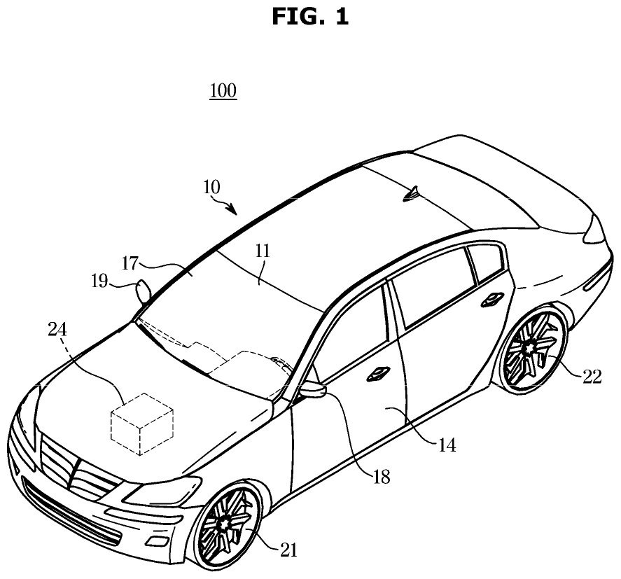

FIG. 1 is a diagram illustrating the exterior of a vehicle according to an embodiment of the present disclosure.

As shown in FIG. 1, a vehicle 1 according to an embodiment of the present disclosure includes a main body 10 forming the outer appearance of the vehicle 1, wheels 21 and 22 for moving the vehicle 100, a battery 24 for powering the electrical components of the vehicle 100, a door 14 for shielding the interior of the vehicle 100 from the outside, a front glass 17 for providing a driver with a forward view of the vehicle 100, side mirrors 18 and 19 for providing a driver with a rearward view of the vehicle 100.

The wheels 21 and 22 include a front wheel 21 provided at the front of the vehicle 100 and a rear wheel 22 provided at the rear of the vehicle 100. The battery 24 supplies power to the various electrical components provided in the vehicle 100 so that the electrical components operate. For example, the battery 24 supplies power to the devices when updating the software of various devices provided in the vehicle 100 so that the update of the software is normally completed.

The door 14 is rotatably provided on the left and right sides of the main body 10 so that the driver may ride inside the vehicle 100 at the time of opening of the door 14 and shield the inside of the vehicle 100 from the outside at the time of closing of the door 14.

The front glass 17 is provided on the front upper side of the main body 10 so that a driver inside the vehicle 100 may obtain a forward view of the vehicle 100. The front glass 17 is also referred to as a windshield glass.

The side mirrors 18 and 19 include a left side mirror 18 provided on the left side of the main body 10 and a right side mirror 19 provided on the right side of the main body 10 so that a driver inside the vehicle 100 may obtain a side view and a rearward view of the main body 10.

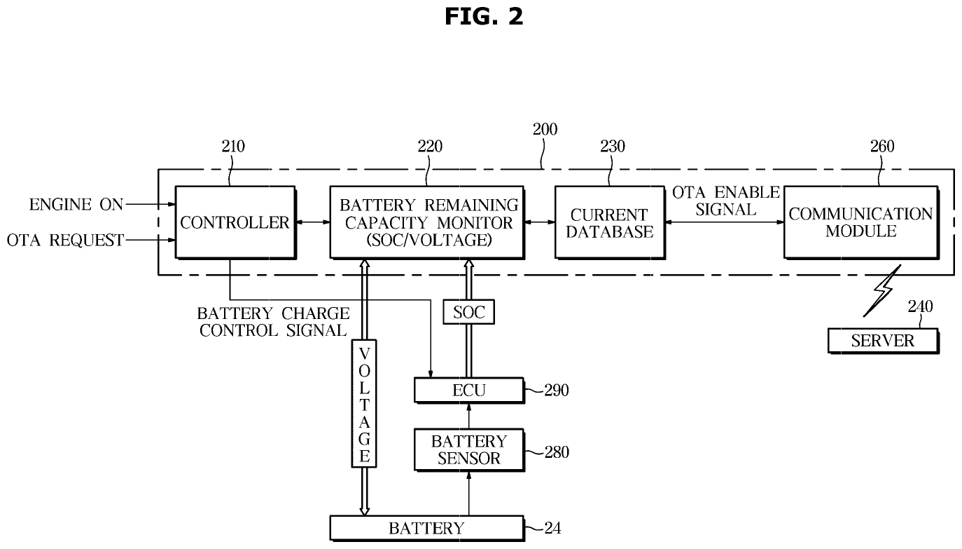

FIG. 2 is a block diagram illustrating a configuration of a software update system of a vehicle according to an embodiment of the present disclosure.

Referring to FIG. 2, a software update system 200 of the vehicle 100 according to an embodiment of the present disclosure includes a controller 210, a battery remaining capacity monitor 220, a current database 230, and a communication module 260.

The controller 210 is a microprocessor that controls the overall operations of the software update system 200 and may control the operations of various modules, devices and the like built in the software update system 200. According to one embodiment, the controller 210 may be operated by a processor built in the software update system 200 and may generate control signals for controlling various modules, devices and the like built in the software update system 200.

The controller 210 may be a head unit controller for performing power supply control of a head unit and updating of a peripheral unit.

The controller 210 may include a memory that stores control data for controlling the operation of the software update system 200, reference data used during operation control of the software update system 200, operation data generated during execution of a predetermination operation by the software update system 200, setting information, such as scheduled update setting data, input by the user for the software update system 200 to perform a predetermined operation.

The controller 210 controls the overall operation of the software update system 200 to update the software necessary for controlling the vehicle 100. The software is updated by OTA (Over The Air) type software update. In the OTA type software update, the software update system 200 of the vehicle 100 receives data necessary for software update from the server 240 through wireless communication and performs software update.

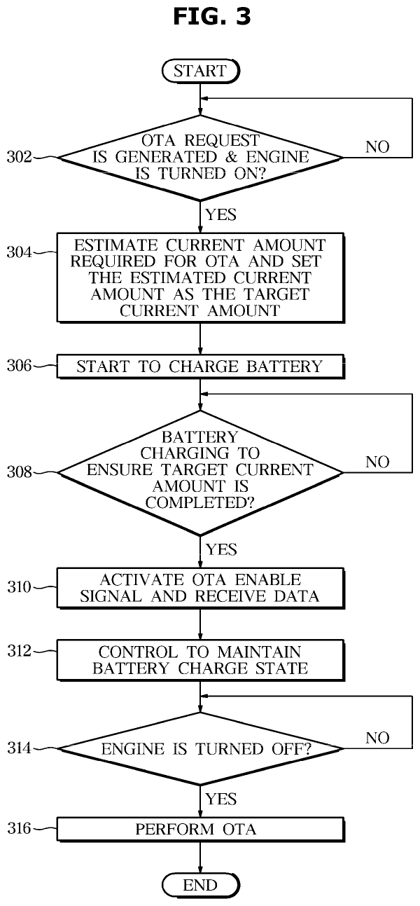

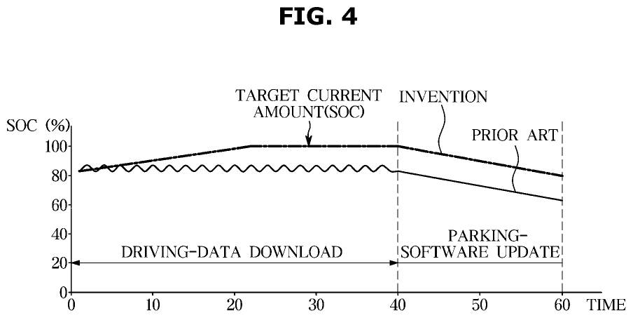

The software update system 200 according to an embodiment of the present disclosure may sufficiently charge the battery 24 while considering the OTA while the vehicle 100 is driving, and when the vehicle 100 is converted to the parking state, update the software by using the charged power of the battery 24 secured in advance while driving. For charge control of the battery 24, the controller 210 may generate a battery charge control signal and transmit the generated battery charge control signal to the vehicle battery controller 290 (Engine Control Unit (ECU)). This will be described in more detail with reference to FIGS. 3 and 4 below.

The battery remaining capacity monitor 220 monitors the state of charge (SOC) of a battery through a battery sensor 280 that is a detector for detecting the charge amount of the battery. As described above, the battery remaining capacity monitor 220 receives the SOC value from the battery sensor 280 and stores the SOC value.

The battery sensor 280 is mounted on the battery 24 that supplies power to the vehicle 100, and is configured to measure the current state of the battery 24 and transmit the measured state of the battery 24 to the battery remaining capacity monitor 220. For example, the amount of remaining voltage and current of the battery 24 may be measured and transmitted to the battery remaining capacity monitor 220. The battery sensor 280 measures the voltage, current, and temperature of the battery 24 to determine the state of charge (SOC) of the battery 24, the state of health (SOH) of the battery 24, and the state of function (SOF) of the battery 24. Battery state information such as voltage, current, SOC, SOH, SOF, and temperature measured by the battery sensor 280 is transmitted to the battery remaining capacity monitor 220 through a vehicle battery controller 290.

The SOC represents the present charge capacity of the battery 24 in relation to the full charge capacity of the battery 24. The SOH also represents the present aging state of the battery 24 relative to a brand new battery. The SOF indicates how the performance of the battery 24 meets actual requirements during the use of the battery 24. The SOF may be determined by the SOC, the SOH, the operating temperature of the battery 24, and the charge/discharge history of the battery 24.

The current database 230 stores predicted current consumption values for parts that are expected when the software update of the part are updated in advance. The predicted current consumption value for each part is obtained in advance by measurement.

The communication module 260 supports exchange of information with an external server 240. The communication module 260 connects the software update system 200 to the server 240 via network so that the server 240 and the software update system 200 may communicate with each other. For example, the communication module 260 may include a wireless fidelity (Wi-Fi) communication module that is connected to a local area network (LAN) through a wireless access point, a Bluetooth communication module that communicates in a one-to-one manner with a single external device or one-to-many with a small number of external devices, a broadcast signal receiving module that receives a digital broadcast signal, and a position information receiving module that receives position information of the vehicle 100 from a satellite.

The communication module 260 may be connected to other devices using a GSM/3GPP-based communication method (GSM, HSDPA, LTE Advanced), a 3GPP2-based communication method (CDMA, etc.), or a wireless communication protocol such as WiMAX.

The communication module 260 may transmit and receive current position information of the vehicle 100 to/from the GPS satellite or transmit and receive map information to/from the server 240 located at a remote location by transmitting and receiving data to/from the GPS satellite. The position information and the map information of the vehicle 100 may be used to provide a driving route for a user to move to a destination set by the user.

In addition, the communication module 260 may be connected to another device to transmit/receive multimedia data. Specifically, the communication module 260 may be connected to a mobile terminal located near the vehicle 100 or a server 240 located remote from the vehicle 100, to transmit multimedia data from the mobile terminal or the server 240.

FIG. 3 is a diagram illustrating a software update method of a vehicle according to an exemplary embodiment of the present disclosure. The software update method shown in FIG. 3 may sufficiently charge the battery 24 while considering the OTA type software update while the vehicle 100 is driving, and when the vehicle 100 is converted to the parking state, perform the OTA type software update by using the charged power of the battery 24 secured in advance while driving. In FIG. 3, ‘OTA’ means ‘OTA type software update’.

As shown in FIG. 3, the controller 210 of the software update system 200 monitors whether an OTA type software update request is generated from a server 240 at a remote location, If the OTA type software update request is generated from the server 240, checks whether the engine of the vehicle 100 is turned on (302). Checking whether the engine is turned on is to perform charging of the battery 24 for OTA type software update while the engine is turned on.

If the OTA type software update request is generated from the server 240 and the engine of the vehicle 100 is turned on, the controller 210 estimates (calculates) the current amount required for the OTA type software update, and sets the estimated current amount as the target current amount (304). If it is assumed that the target of the software update is three electronic control units (ECUs), the current amount required to perform the software update of each of these three ECUs may be sufficiently secured through experiments in advance. Therefore, when the targets for the software update are determined, the total current amount required for the software update may be estimated.

The OTA type software update may be divided into a process of receiving data necessary for update and a process of performing necessary update using the received data. In an embodiment of the present disclosure, the reception of data required for update is performed when the engine of the vehicle 100 is turned on, the software update is executed when the vehicle 100 finishes driving and the engine is turned off. Since the software is in use while the vehicle 100 is driving, the software update cannot be attempted. Receiving data necessary for update the software may be performed with relatively little power, but the software update requires a relatively higher power consumption since it must be performed after the relevant device has been electrically activated (i.e., powered on). For this reason, in the embodiment of the present disclosure, while the vehicle 100 is driving, the power necessary for the software update is sufficiently secured in advance while driving, and when the vehicle 100 finishes driving, the software is updated in the engine's turn-off state using the sufficient power already secured.

When the target current is set by estimating the current amount required for OTA type software update, the controller 210 starts to charge the battery 24 through the battery remaining capacity monitor 220, the battery sensor 280, and the ECU 290 (306). At this time, the controller 210 controls the charging of the battery 24 such that the charge amount of the battery 24 exceeds the target current amount set in step 304. In other words, the controller 210 controls the charging of the battery 24 so that the battery 24 is charged more than the current amount required for OTA type software update.

The controller 210 identifies whether the charging of the battery 24 is completed so that the charge amount of the battery 24 exceeds the target current amount set in step 304 (308).

When the charge of the battery 24 is completed so that the charge amount of the battery 24 exceeds the target current amount set in step 304 (‘YES’ in 308), the controller 210 activates and transmits the OTA enable signal to the communication module 260 and controls the communication module 260 and the server 240 to communicate with each other to receive data necessary for OTA type software update (310).

In addition, the controller 210 continuously manages the charging of the battery 24 so that the charge amount of the battery 24 is maintained above the target current amount while the vehicle 100 is driving (312). Since the OTA enable signal is activated and the data necessary for the software update is received, the OTA type software update is performed immediately when the vehicle 100 finishes driving and the engine is turned off. Therefore, it is necessary to continuously manage the charging of the battery 24 so that the charge amount of the battery 24 is maintained above the target current amount before the vehicle 100 finishes driving.

The controller 210 identifies whether the vehicle 100 finishes driving and the engine is turned off (314).

When the vehicle 100 finishes driving and the engine is turned off (‘YES’ in 314), the controller 210 performs an OTA type software update using sufficient power of the battery 240 already secured while driving (316). The data used for OTA type software update is received from the server 240 while the vehicle 100 is driving. If the date reception is not possible while the vehicle 100 is driving, necessary data may be received after the vehicle 100 finishes driving before performing the OTA type software update.

FIG. 4 is a view illustrating a state change of a battery during software update according to an exemplary embodiment of the present disclosure. FIG. 4 shows the state of the battery compared with the case of the prior art when the OTA type software update according to an embodiment of the present disclosure is performed.

As shown in FIG. 4, in the OTA type software update system according to an exemplary embodiment of the present disclosure, necessary data is downloaded (received) during driving of the vehicle 100, and the OTA type software update is performed when the vehicle 100 is parked after driving.

In the conventional case, as shown in the graph labeled ‘prior art’ in FIG. 4, if the battery 24 is insufficient because the battery 24 is not sufficiently charged while the vehicle 100 is driving, an OTA type software update may not be performed when the engine 100 is turned off.

On the contrary, as shown in the graph labeled ‘disclosure’ in FIG. 4, the controller 210 according to the embodiment of the present disclosure controls the battery 24 to be charged to the target current amount required for software update while the vehicle 100 is driving, and when the vehicle 100 finishes driving and the engine is turned off, performs the OTA type software update by using the power of the charged battery 24. As a result, a situation in which the software update fails due to the power shortage of the battery 24 does not occur.

According to an aspect of the present disclosure, the software update of the vehicle may be completed stably by ensuring sufficient charge of the battery in consideration of the software update of the vehicle

The above description is merely illustrative of technical ideas, and various modifications, alterations, and permutations will be possible without departing from the essential characteristics of those skilled in the art. Therefore, the embodiments and the accompanying drawings described above are intended to illustrate and not limit the technical idea, and the scope of technical thought is not limited by these embodiments and the accompanying drawings. The scope of which is to be construed in accordance with the following claims, and all technical ideas which are within the scope of the same shall be construed as being included in the scope of the right.

1. A method for software update of a vehicle, comprising:
securing a battery charge amount required for a software update of the vehicle by charging the battery while the engine of the vehicle is turned on; and
performing the software update of the vehicle using the power of the battery while the engine of the vehicle is turned off.

2. The method of claim 1, further comprising:
receiving a software update request; and
charging the battery and performing the software update in response to the software update request.

3. The method of claim 2, further comprising:
receiving a data required for software update of the vehicle in response to receiving the software update request.

4. The method of claim 3, further comprising:
receiving the data necessary for software update of the vehicle while the engine of the vehicle is turned on.

5. The method of claim 2, further comprising:
estimating a current amount required for software update of the vehicle in response to receiving the software update request; and
setting a target current amount of the battery based on the estimated current amount.

6. The method of claim 1, wherein the securing the battery charge amount comprises:
maintaining the state of the battery charge such that the battery charge amount exceeds the current amount required for the software update while the engine of the vehicle is turned on.

7. The method of claim 1, wherein the software update of the vehicle comprises a software update of the over-the-air (OTA) type software update for receiving the data necessary for the software update of the vehicle through a wireless communication network.

8. A system for software update of vehicle, comprising:
a detector for detecting a battery charge amount; and
a controller configured to secure the battery charge amount required for software update of the vehicle by charging the battery while the engine of the vehicle is turned on and perform the software update of the vehicle using the power of the battery while the engine of the vehicle is turned off.

9. The system according to claim 8, wherein the controller is configured to receive a software update request, charge the battery and perform the software update in response to the software update request.

10. The system according to claim 9, wherein the controller is configured to receive a data required for software update of the vehicle in response to receiving the software update request.

11. The system according to claim 10, wherein the controller is configured to receive the data necessary for software update of the vehicle while the engine of the vehicle is turned on.

12. The system according to claim 9, wherein the controller is configured to estimate a current amount required for software update of the vehicle in response to receiving the software update request and set a target current amount of the battery based on the estimated current amount.

13. The system according to claim 8, wherein the securing a battery charge amount comprises:
maintaining the state of the battery charge such that the battery charge amount exceeds the current amount required for the software update while the engine of the vehicle is turned on.

14. The system according to claim 8, wherein the software update of the vehicle comprises a software update of the over-the-air (OTA) type software update for receiving the data necessary for the software update of the vehicle through a wireless communication network.

15. A method for software update of a vehicle, comprising:
receiving an OTA type software update request;
securing a battery charge amount required for a software update of the vehicle by charging the battery while the vehicle is driving;
receiving a data necessary for software update of the vehicle while the vehicle is driving in response to receiving the software update request; and
performing the software update of the vehicle using the power of the battery while the vehicle is parked.

16. The method of claim 15, further comprising:
estimating a current amount required for software update of the vehicle in response to receiving the software update request; and
setting a target current amount of the battery based on the estimated current amount.

17. The method of claim 15, wherein the securing the battery charge amount comprises:
maintaining the state of the battery charge such that the battery charge amount exceeds the current amount required for the software update while the engine of the vehicle is turned on.

18. A method for software update of a vehicle, comprising:
receiving an OTA type software update request;
estimating a current amount required for software update of the vehicle in response to receiving the software update request;
setting a target current amount of the battery based on the estimated current amount;
control the battery charge amount to be maintained above the target current amount by charging the battery while the vehicle is driving;
receiving a data necessary for software update of the vehicle while the vehicle is driving in response to receiving the software update request; and
performing the software update of the vehicle using the power of the battery while the vehicle is parked.
